(19) United States
(12) Patent Application Publication
(10) Pub. No.: US 2004/0050451 A1
(43) Pub. Date: Mar. 18, 2004

(54) Machine tool jig

(76) Inventor: Erich Dahlhoff, Berkhamsted (GB)

Correspondence Address: Bradley N Ruben, Suite 5-A, 463 First St, Hoboken, NJ, 07030-1859, US

(21) Appl. No.: 10/466,190

(22) PCT Filed: Jan. 21, 2002
(86) PCT No.: PCT/GB02/00253

(30) Foreign Application Priority Data
Jan. 19, 2001 (GB) 0101418.2
Dec. 18, 2001 (GB) 0130186.0

(51) Int. Cl. B27C 5/00

(52) U.S. Cl. 144/144.1

(57) ABSTRACT

A jig for a machine tool used in joinery, such as a portable router or the like, and which is suited for forming joints having compound angles, the jig suitably comprising: a work-piece mounting board means (11) having means (12) to releasably secure a work piece thereto; and a template board means (5) overlying the mounting board means (11) and against which the machine tool abuts, in use, and defining a template aperture (6) for guiding the machine tool in a pre-defined path relative to the work-piece to machine the work-piece, the template board means (5) and work piece mounting board means (11) being movable in more than one plane relative to each other to selectively position the work-piece at chosen angles of tilt relative to the work piece and releasably fastenable at the selected position, so that a compound angle joint may be machined by moving he machine tool around the template aperture and without need to re-adjust the position of the work-piece. The template aperture (6) may be adjusted to suit the form to be on the work-piece.

### FIELD OF THE INVENTION

The present invention concerns improvements in and relating to a jig for a machine tool such as a portable router or the like and which is particularly suited for forming joints such as, for example, tenons having compound angles.

### BACKGROUND OF THE INVENTION

Compound angles are present in much of the joinery in furniture such as chairs (being particularly useful to join a side seat rail to a chair's back leg, for example) but also in many tables, beds and even fixed fittings such as stair rails. However, they are difficult and time-consuming for any but professional joinery companies to form using large, complex and expensive machine tool installations. As a generality, the facilities available for the small professional/amateur woodworker are very limited in their capabilities for forming joints and require careful marking up and repeated steps of re-positioning and adjusting the work-piece in a vice to saw the different angles that make up the compound angle joint.

An outline of this normal procedure for making such joints is given in the July/August 2000 edition of the US published Journal “Fine Woodworking””.

To the best of the applicants knowledge, no simple, compact, cost effective and versatile machine tool jig exists that is capable of making a wide range of compound angle joints simply, quickly and reliably. It is a general objective of the a, present invention to address this fundamental shortcoming of the prior art.

### SUMMARY OF THE INVENTION

According to a first aspect of the present invention there is provided a machine tool jig which comprises a template board means having an aperture therethrough and to which a machine tool having a cutting head (suitably a rotary cutting tool, such as a router) is mounted in use with the cutting head of the machine tool extending through the aperture to be guided by the perimeter of the aperture relative to a work piece, the opening of the aperture being selectively adjustable in extent to adjust the form to be cut.

Preferably the template aperture is defined between a first section of the template board means and a second section of the template board means, the first section being moveable toward or away from the second section to adjust the opening of the template aperture.

According to a further aspect of the present invention there is provided a jig for a machine tool used in joinery, such as a portable router or the like, and which is suited for forming joints having compound angles, the jig comprising:

a work-piece mounting board means having means to releasably secure a work piece thereto; and

a template board means overlying the mounting board means and against which the machine tool abuts, in use, and defining a template aperture for guiding the machine tool in a pre-defined path relative to the work-piece to machine the work-piece, the template board means and work piece mounting board means being movable in more than one plane relative to each other to selectively position the work-piece at chosen angles of tilt relative to the work piece and releasably fastenable at the selected position, so that a compound angle joint may be machined by moving the machine tool around the template aperture and without need to re-adjust the position of the work-piece.

The jig may suitably be configured as a wall mounting shelf or as a table to present the template board means in a substantially horizontal plane whereby the machine tool may be seated upon the template board means and supported thereby in use.

In this arrangement the template board means hangs from the jig beneath the work-piece board means. It is suitably free to swing through an appropriate angle fore and aft of the jig and preferably the work-piece mounting board means may be turned in its plane.

The template aperture of the template board means is preferably adjustable in shape and size—suitably having front and rear sections that may be moved closer together or farther apart. This enables, for example, different widths of tenon to be accommodated for. The template board means suitably further has adjustably positionable lateral sections intermediate the front and rear sections that may be put closer together or farther apart. This enables adjustment for different lengths of tenon, for example.

In a particularly preferred embodiment the template aperture has an elongate slot shape with rounded ends. By providing rounded ends in the template aperture the woodworker is saved the further task of having to shape the tenon joint or the like with a chisel or other tool once he has formed the required compound angle configuration of the joint.

The jig suitably further has a fence-board means that is suitably pivotally mounted to the work-piece mounting board means, directly or indirectly, to tilt across the face thereof.

Preferably the template board means is mounted to a frame of the jig so that it may move longitudinally fore or aft of the jig to assist in properly aligning the template aperture over the work-piece.

It is also preferred that the securing means provided on the work-piece mounting board means are adjustably positionable laterally of the jig. These are suitably mounted in slots extending rectilinearly across the work-piece mounting board means.

Preferably the work-piece mounting board means is mounted to a backing board means, which backing board means is pivotally mounted to the template board means, directly or indirectly, and where the work-piece mounting board may be moved laterally across the face of the backing board means to adjust the lateral alignment of the work-piece relative to the template aperture.

Suitably the template board means is mounted to a support board overlying a major aperture in the support board and is positioned between a pair of guide rails on the support board so as to be slideably moveable across the major aperture in the support board.

Advantageously the template board means has a centring aperture to receive a dowel hole-forming cutting head therethrough.

### BRIEF DESCRIPTION OF THE DRAWINGS

A preferred embodiment of the present invention will now be more particularly described, by way of example, with reference to the accompanying drawings, wherein:

FIG. 1 is a perspective view of a machine tool jig from above and to the left, and showing a workpiece mounting plate at a first angle of incline;

FIG. 2 is a perspective view of the machine tool jig that is substantially the same as the view in FIG. 1, but showing the workpiece mounting plate at a second angle of incline;

FIG. 3 is a perspective view of the machine tool jig from the front, slightly to the right hand side and slightly from below, the workpiece mounting plate being at substantially the same angle of incline as in FIG. 1, and further showing a workpiece positioning plate at a first angle of incline;

FIG. 4 is a perspective view of the jig from substantially the same orientation as FIG. 3, but showing the workpiece positioning panel (fence board) at a second angle of incline;

FIG. 5 is a perspective view of the jig from above and to the right hand side, with the workpiece mounting plate at the second angle of incline (as per FIG. 2) and further showing the machining template of the jig turned to a position which is several degrees out of alignment with the main “table” plane of the jig;

FIG. 6 is a perspective view of the jig from below and to the right hand side; showing the jig in substantially the same configuration as illustrated in FIG. 5;

FIG. 7 is a perspective view of the jig from above showing a routing machine tool mounted over the template with the routing head of the tool positioned over the template aperture of the template;

FIG. 8 is a side elevation view of a compound angled tenon;

FIG. 9 is an end elevation view of the tenon of FIG. 8;

FIGS. 10a, 10b and 10c are respective plan views of first, second and third template board arrangements;

FIG. 11 is a perspective view of a yet further alternative template board and which is especially suited for forming square or round-backed dovetails;

FIG. 12 is a perspective view of a compact jig assembly base suitable for use with, for example, the FIG. 11 template and showing a plank installed on the mounting board of the jig assembly base in a position for cutting of square backed dovetails at the end of the plank;

FIG. 13 is a perspective view of the assembly of FIG. 12 with the jig template installed over the plank end for cutting the square backed tails;

FIG. 14 is a perspective view similar to FIG. 13 but from a rearward direction and showing the template positioned for cutting of dovetail pins (sockets) in a plank end mounted in the mounting assembly of the jig;

FIG. 15 is a perspective view similar to FIG. 14, again from a rearward position, and with the template configured for cutting of round-backed dovetails in a plank end; and

FIG. 16 is a view similar to FIG. 14 but with the template configured for cutting of round-backed pins (tail sockets) at an end of a plank which is positioned flat on the upper support board of the jig assembly base beneath the template.

### DESCRIPTION OF THE PREFERRED EMBODIMENT

In a first embodiment the machine tool jig of the present invention is suitably assembled from a number of boards of plywood or MDF or the like and comprises a base board 1 which is suited for standing the jig upon a work bench or other surface and which extends beyond the main body of the jig to the rear and to the sides to enable the base board to be clamped to the workbench or other surface.

Upstanding from the base board 1 are a pair of side walls 2, 3 substantially perpendicular to the base board 1 and substantially plane parallel to each other. These side walls 2, 3 and a back board (not shown) support a table board 4 which bridges between them and which carries a template board 5 on its upper face.

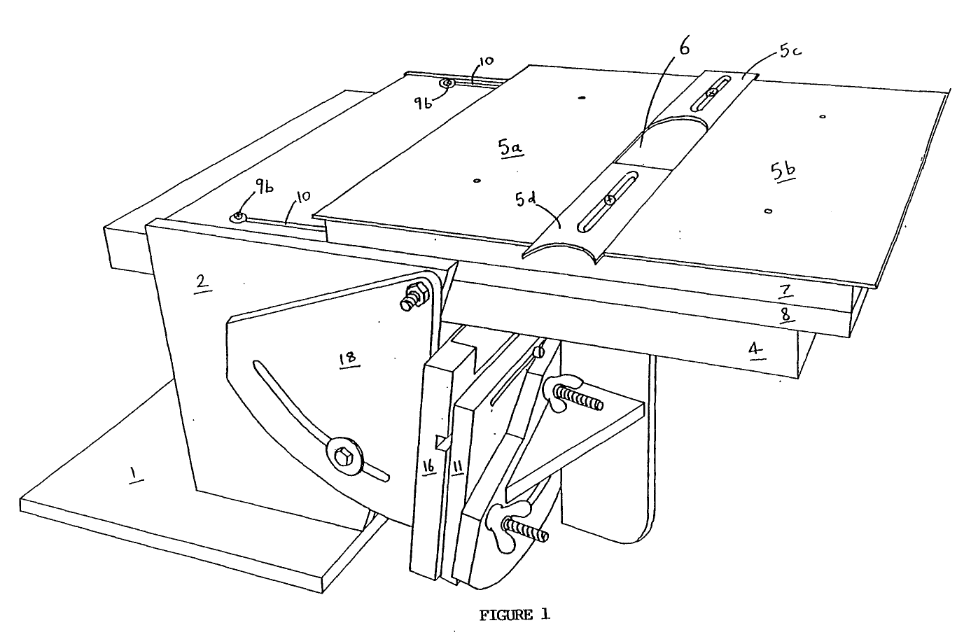

The template board 5 is, in fact, not one single board but is, in the illustrated form, comprised of four board sections—front and rear 5a, 5b major sections and intermediate lateral sections 5c, 5d. The relative position of the board sections 5a-d of the template board 5 define the size and, to some extent, the shape of the template aperture 6 that is followed by the router or other machine tool in use. The intermediate lateral sections 5c, 5d have an outer straight edge and an inner rounded edge and either may be reversed in orientation (see right hand Section 5c in FIG. 1 so that the rounded edge is laterally outermost, if desired

The sections 5a-d that together comprise the template board 5 are adjustably mounted to the table board 4 via intermediacy of upper 7 and lower 8 template board support boards.

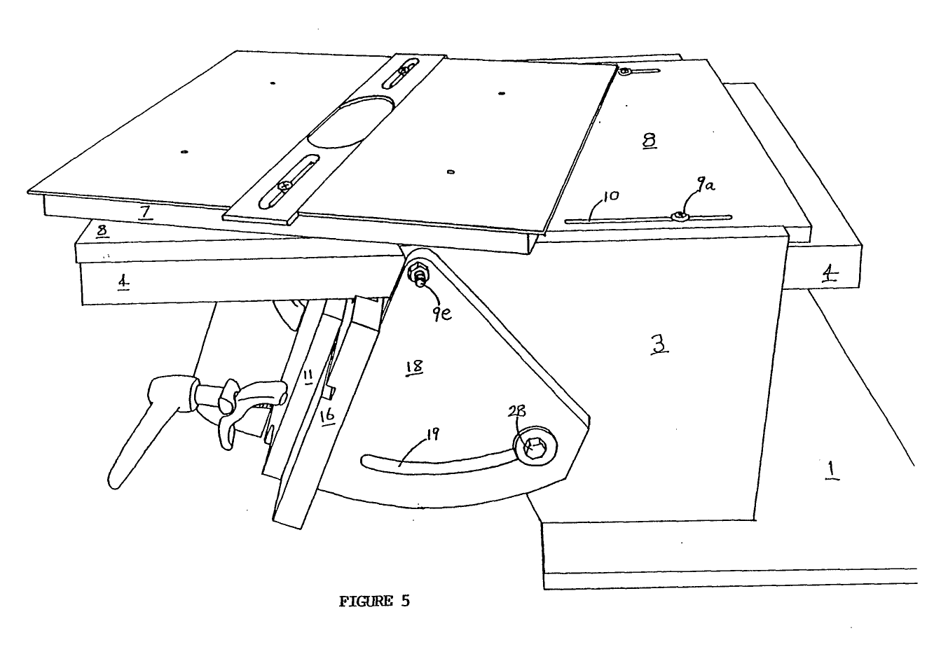

The upper support board 7 carries the template board sections 5a-d securely fastened thereto in a chosen configuration. Upon loosening the screws the major sections 5a, 5b may be increased or reduced in separation by moving the screws within longitudinal slots in the support board 7. Similarly the lateral sections 5c, 5d may be moved together or apart by being screwed to the support board 7 through lateral elongate slots 29 in the template board 5. The lower template board support board 8 has the upper support board 7 mounted thereto via bolts or pins 9a that extend through arcuate slots in the lower support board 8 to enable the upper support board 7 with the template board 5 to be skewed relative to the table board 4, as can best be seen in FIGS. 5 and 6.

The lower support board 8 is, furthermore, adjustably mounted to the table board 4 again by bolts or pins 9b which extend up through longitudinal slots 10 formed in the lower support board 8 to enable longitudinal adjustment of the position of the template aperture to front and rear of the jig.

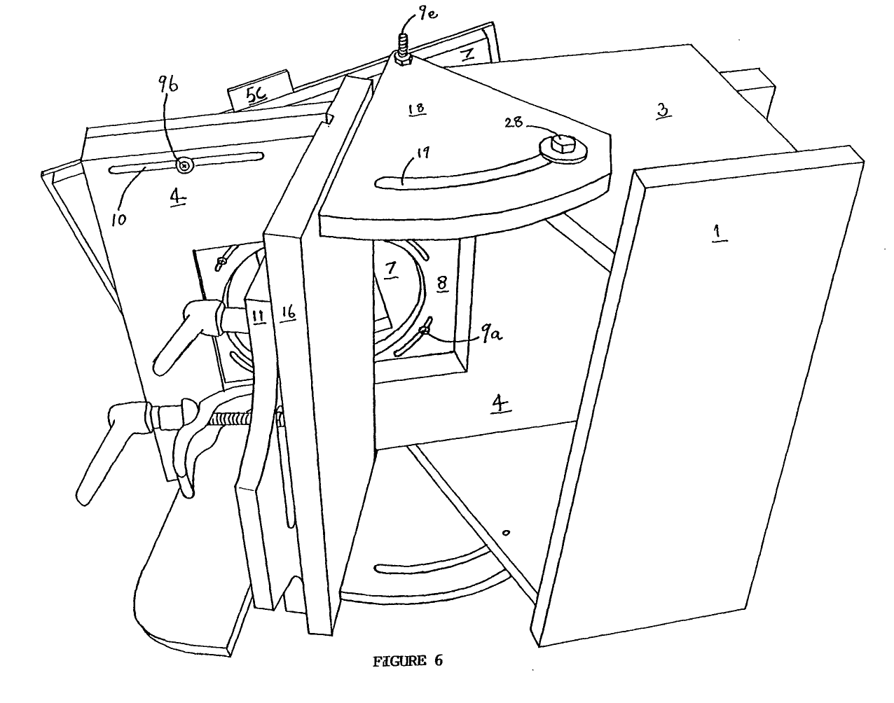

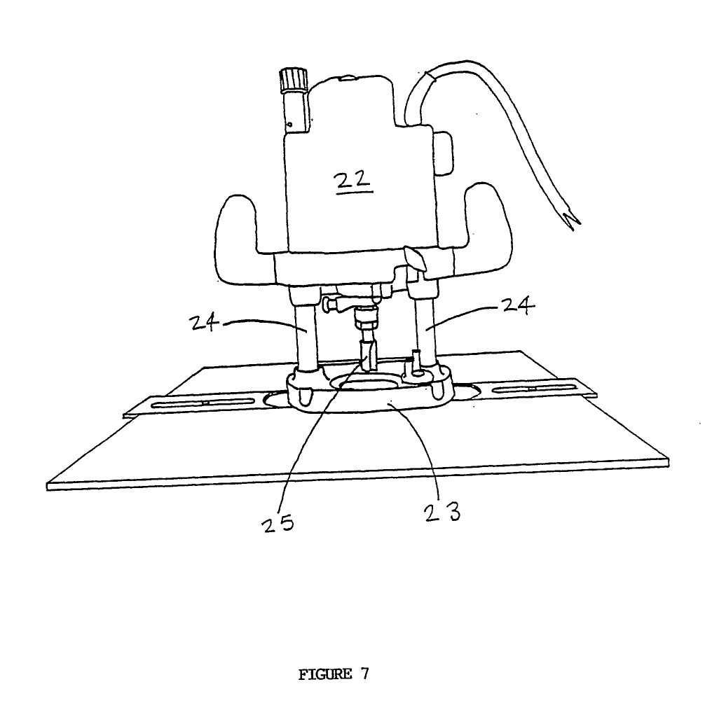

The jig 1 is adapted to support a router or other machine tool standing on the top of the template board 5 and a work-piece held beneath the template board 5 in order for the work-piece to be worked on by a head of the tool, e.g. router 22 (see FIG. 7), that extends down through the template aperture 6.

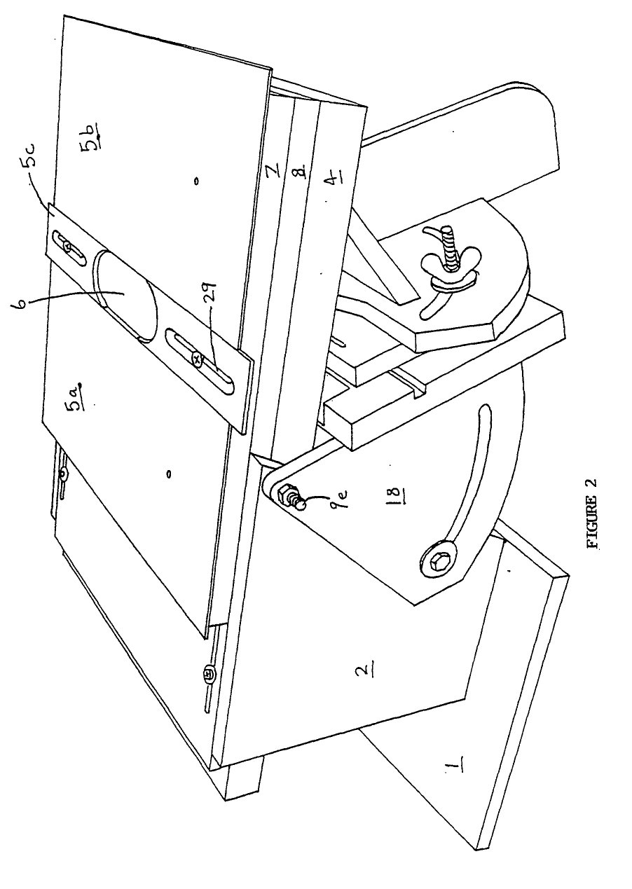

The work-piece (not shown) is clamped to a work-piece mounting board 11 which is pivoted to hang beneath the table board 4 in a substantially vertical plane but which may be pivoted backwardly and forwardly to differing angles of incline to the vertical as illustrated in FIGS. 1 and 2.

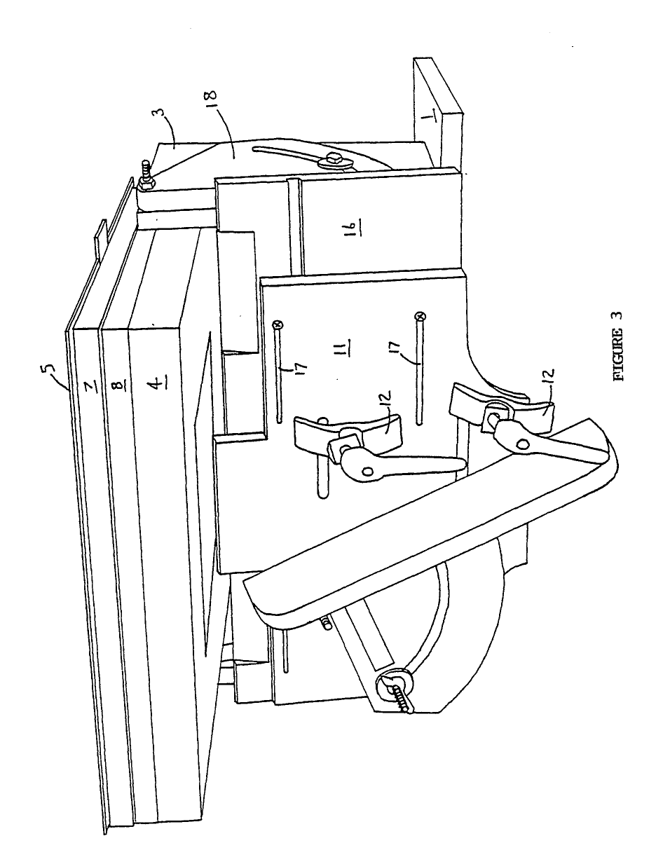

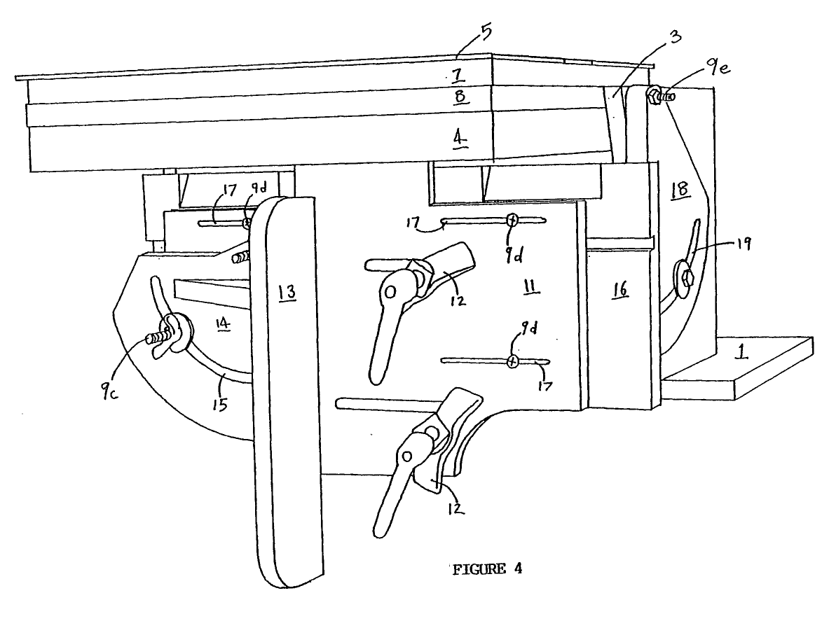

The work-piece mounting board 11 carries a pair of clamps 12 to releasably secure a work-piece thereto, the clamps 12 being mounted in transverse slots on the work-piece mounting board 11 to be movable transversely of the jig to a desired clamping position and to clamp the work-piece relative to the work-piece positioning panel (or “fence board”) 13 that is adjustably mounted to the work-piece mounting board 11 projecting substantially plane perpendicularly to the work-piece mounting board 11. This positioning panel 13 remains fixed substantially perpendicular to the work-piece mounting board 11 throughout but may be tilted to any of a range of different angles of incline beneath the table board 4 as can be seen, for example, in FIGS. 3 and 4.

The positioning panel 13 as a mounting plate portion 14 projecting therefrom that lies plane parallel to and lies over the surface of the work-piece mounting board 11. This mounting plate portion 13 is pivoted at its upper end to the mounting board 11 and has a bolt 9c extending there through capped with a wing nut—this bolt 9c protrudes through an arcuate slot 15 in the mounting plate portion 14 which enables the positioning panel 13 to be moved relative to the bolt 9c to adjust the angle of incline and to be fastened to a desired position by tightening the wing nut on the bolt 9c. This adjusts the angle of incline of the positioning panel 13 in the plane that extends transversely of the jig.

The angle of incline of the work-piece mounting board 11 fore and aft of the jig is, as noted previously, by virtue of pivotal mounting of the mounting board 11 to the table board 4.

The nature of this mounting can be readily seen in FIGS. 1 and 2. The work-piece mounting board 11 is pivoted to the table board 4 via the intermediacy of a backing board 16 that lies behind the work-piece mounting board 11 and to which the work-piece mounting board 11 is mounted via bolts 9d extending through transverse slots 17 in the work-piece mounting board 11. This enables adjustment of the position of the work-piece mounting board 11 transversely of the jig.

The backing board 16 has generally triangular shaped mounting wings 18 fastened thereto which flank the jig on either side and which pivotally mount to the table board 4 by respective pivot pins 9e.

The angle of inclination of the work-piece mounting board 11 fore and aft of the jig may be set by tightening a nut on a respective bolt 28 extending from each side wall 2, 3 of the jig and through an arcuate slot 19 in the corresponding triangular mounting portion of the mounting board 11 backing board 16.

Referring to FIGS. 7, 8 and 9, a compound angle mortise 30 of the type that would be suitable for a joint between a side rail 40 and back leg of a chair (not shown) can be very simply formed using the jig of the present invention.

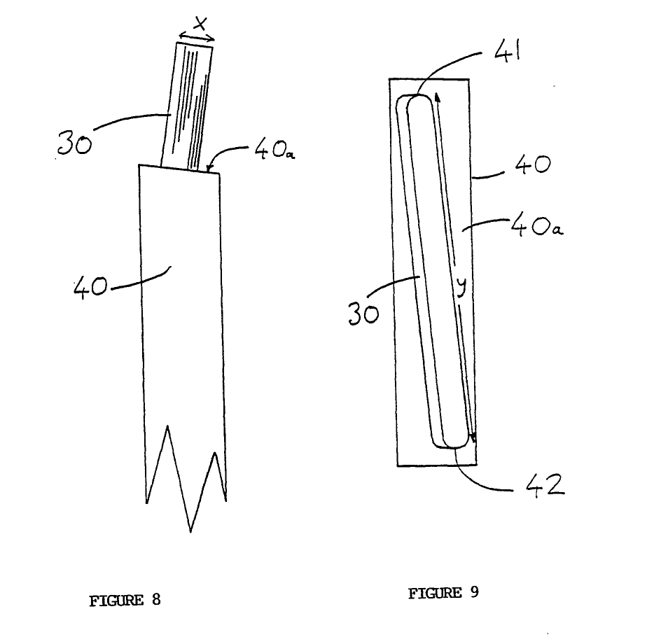

The tenon 30 illustrated in FIGS. 8 and 9 is, as can be seen, not only not aligned with the axis of the rail 40 since it is designed to enter the back leg of the chair at an obtuse angle in the plane of the seat of the chair—(otherwise known as a trapezoidal angle)—but it is also not (as can be seen clearly in FIG. 9) aligned with the vertical axis of the end section 40a of the rail (this is to allow for an inward angle of cant of the chair back leg).

A further point that will be noted from FIGS. 8 and 9 is that the tenon 30 has rounded top 41 and bottom 42 ends. These rounded ends 41, 42 of the tenon 30 can be formed using the jig of the present invention without need for any extra work on the part of the woodworker.

To use the jig, a router 22 is shown in FIG. 7 as being placed on the template board 5 directly overlying the template aperture 6. As with most portable routers 22, the router 22 has its own support stand comprising a support ring 23 and legs 24 to enable the cutting end 25 to be lowered into place or kept raised out of the way (as illustrated in FIG. 7).

The cutting head 25 will cut to a depth that is pre-determined by the length of the legs 24 and the operative length of the cutting head 25 which may be as far back as the bushing 26 that mounts the cutting head 25 to the drive of the router 22.

As can be further seen from FIG. 7, the portable router 22 has handles on either side to enable it to be moved with ease by the woodworker and well away from the cutting head 25.

To set up the jig to make a compound angle tenon of the type illustrated in FIGS. 8 and 9 the rail 40 or other wood work piece is first placed on the work-piece mounting board 11 and secured in place by adjusting the clamps 12 to the desired lateral position over the work-piece and tightening the clamps 12. The work-piece positioning panel/fence board 13 may be adjusted in tilt about its pivotal mounting to the work-piece mounting board 11, if desired. This may be appropriate if the end face/section 40a of the rail 40 and leading face 30a of the tenon 30 is not to be plane perpendicular to the main (longitudinal) plane of the rail 40.

The angle of the tenon 30 to allow for the angle of cant of the chair back leg may be set by adjusting the position of the template board 5 through its turning freedom of movement (ie skewing it) in what is here a substantially a horizontal plane. The bolts, pins or screws 9 that hold the upper support board 7 in a fixed position on the lower support board 8 are loosened and the upper support board 9 is moved, moving the screws, bolts or pins 9 along the arcuate slots 19 of the lower support 8 until the desired position is reached, whereupon the bolts or pins 9a are tightened to fasten the upper support board 7 with its template board 5 in position.

In order to adjust the orientation of the work-piece rail 40 to set for the trapezoidal angle between the rail 40 and chair leg, the work-piece mounting board 11 is adjusted in its angle of inclination fore and aft of the jig. As noted previously, this is achieved by loosening the nut on each bolt 18 by means of which the workpiece mounting board 11 is pivotally fixed to the table board 4 and then swinging the work-piece mounting board 11 fore or aft to the appropriate degree of incline before re-tightening the nuts.

In order to determine the shape of the end face 30a of the tenon 30, the template board front and rear 5a, 5b major sections are advanced toward each other until the separation between them corresponds to the position at which the working head of the router 22 will cut the end of the rail 40 to the required width x.

The lateral intermediate sections of 5c and 5d of the template board 5 are then advanced together to define the required separation for the cutting head 25 of the router 22 to cut the tenon 30 to the required length y. Since it is desired to make the top and bottom ends 41, 42 of the tenon 30 rounded, both lateral and immediate sections 5c 5d are turned so that their rounded faces point inwardly toward the cutter head 5, as illustrated in FIG. 2 for example.

The template boards sections 5a-5d are then all secured in this selected position and the head 25 of the router 22 may be lowered and energised to begin cutting into the end of the rail 40. The bush of the cutting head 25 is held hard up against the edge of the aperture 6 and the operator simply pushes the router 22 to slide over the top surface of the template board 5 with the bush of the cutting head 25 following the edge of the aperture 5 and thereby cutting the tenon to the required shape.

Accordingly, by a few simple adjustments to the jig whilst setting up the jig for use the work-piece is positioned relative to the tool and the tool will move relative to the work-piece in the required manner to form the required compound angle joint without any further adjustment having to be made. This makes the jig of the present invention far more simple and straightforward to use than any conventional jig for the purpose, while having a high degree of versatility. The jig is also relatively simple and cheap to construct and may readily be sufficiently compact and lightweight to be portable.

Although described above with respect to one preferred embodiment, numerous alternative embodiments of the invention are conceivable within the scope as claimed.

For example, the jig need not be formed of a self supporting table structure but could be configured as a shelf to be secured to a wall or other support structure. Furthermore, detailed improvements may be made to the shape and manner of mounting of the template board sections 5a-5d. These (particularly the major sections 5a, 5b) may, for example, be mounted to pivot relative to each other in order to define joints which would have a tapered transverse section. (In the context of the tenon nut 30 illustrated in FIGS. 8 and 9, this would correspond to the face/section 30a tapering from the top end 41 to the bottom end 42, or vice-versa). This may be useful for dovetail type joints such as are used in, for example, the leg-to-table joint of a pedestal table.

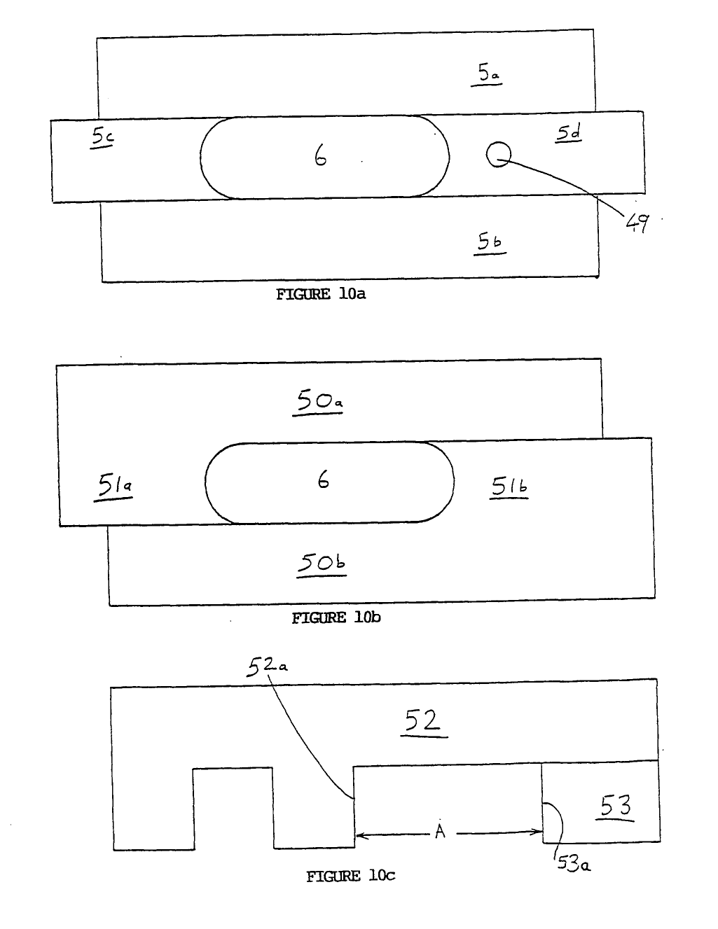

Referring to FIGS. 10a to 10c, these show different arrangements of template board 5 that may be adopted to define the desired template aperture 6. In FIG. 10a the configuration is as in the FIG. 1 embodiment and comprises front and rear major sections 5a, 5b and intermediate lateral sections 5c and 5d with at least the intermediate lateral sections 5c, 5d being moveable together or apart to adjust the size of the aperture 6. An additional feature shown in FIG. 10a is the provision of a circular aperture 49 in one or both of the intermediate lateral sections 5c, 5d. This aperture 49 accommodates the guide bush of a router to enable the blade of the router to cut out a dowel socket. This is very straightforward to use and might, for example, be used following marking of suitable dowel positions by compass on to the end of the workpiece at the requisite position and then centrering the guide aperture over the marking to guide the router cutting head to the required position.

Referring to FIG. 10b, this shows a variant of template in which the aperture 6 is defined between a pair of plates 50a, 50b. One of which functions as the rear plate 5a and with a forward extension 51a at its notional right-hand end in place of the right-hand intermediate lateral section 5c and the other of which 50b functions as a front section and has a left-hand extension 51b that replaces the left-hand lateral intermediate section 5c. The front 50a and rear 50b template sections are moveable laterally toward or away from each other to extend or decrease the width of the aperture 6 defined therebetween.

Referring to FIG. 10c, here the template takes the form of a largely one-piece plate construction but having a separately moveable right-hand extension section 53, which is moveable laterally toward or away from the shoulder extension 52a defining the width A of the slot or aperture 6. The template of FIG. 10c may be employed very usefully in formation of dovetails/pins.

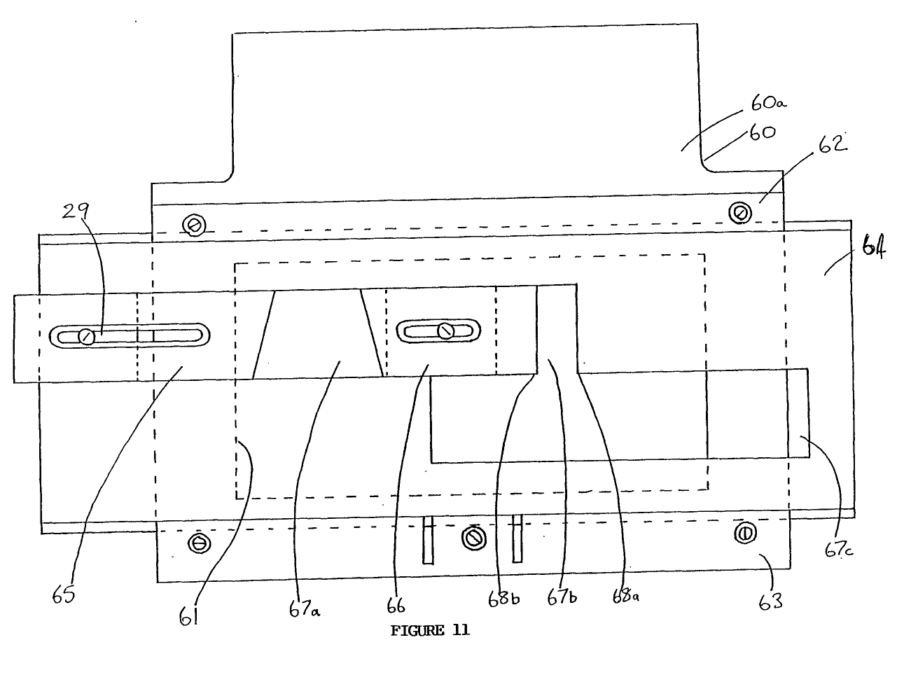

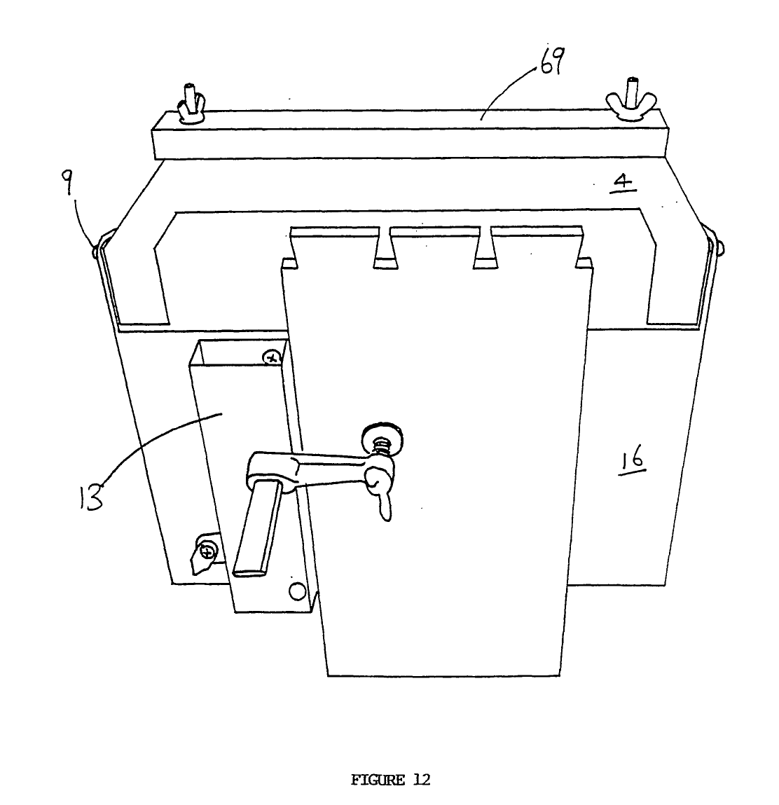

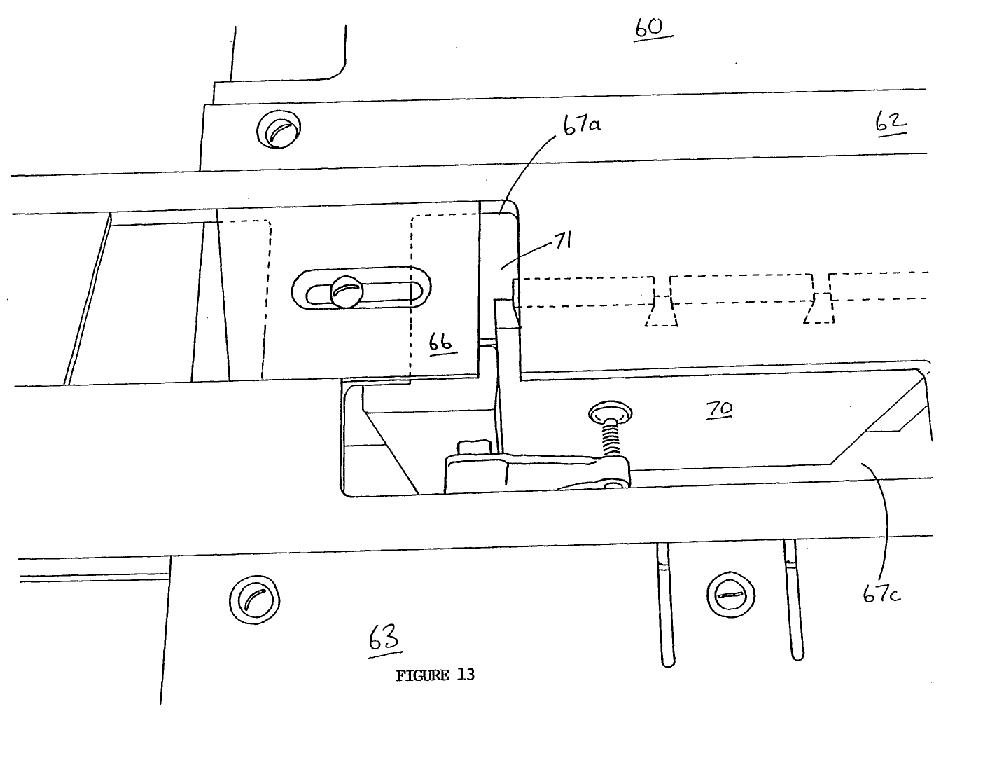

Turning to FIG. 11, this illustrates a template assembly suited for forming dovetails including round backed as well as square backed dovetails and corresponding pins (dovetail sockets). FIG. 11 shows a modified upper template support board 60. This upper support board 60 as illustrated takes the form of a thick metal plate that defines a major rectangular aperture 61 in its foreportion and over which mounts the main template board 64. This new configuration of upper support board 60 is adapted to be used with a more compact jig assembly base as illustrated in FIG. 12 and which is clamped to the table board surface 4 of the jig assembly base by a clamping bar 69 which clamps down over a rearwardly extending portion 60a of the upper support board 60.

The template board 64 of the FIG. 11 embodiment sits between front 63 and rear 62 rails on the upper support board 60 extending parallel to the front and rear edges of the major aperture 61 so that the template board 64 is slidable laterally, i.e. to the left or right across the face of the major aperture 61.

The template board 64 itself has an aperture or channel 67 that suitably extends from one end (illustrated as the left hand end) of the template board 64 for much of the length of the board 64 and which is suitably for much or all of its length a through aperture from the face of the board 60 to the other. The first length 67a extends substantially longitudinally inwardly from the left-hand end of the base board 64, i.e. in the lateral direction traversing the major aperture 61 of the upper support board 60. This then deviates in a short perpendicular dog-leg 67a and then extends again in the lateral direction as a final channel/aperture length 67c.

A pair of template board insert sections 65, 66 are provided and which mount, as illustrated, within the first length 67a of the channel/aperture 67 and which are free to move, within limits, along the first lengths 67a of the channel/aperture 67. Each of these laterally moveable insert sections 65, 66 has its extent of movement restricted by a pin in slot 29 arrangement, and each 65, 66 is removable from the channel 67 and replaceable in a different position/orientation within the channel 67 to suit different uses. In the position and configuration illustrated in FIG. 11 and FIG. 13, the template board 64 is positioned in a way that primarily suits formation of straight-backed dovetails.

In FIG. 13 a plank is mounted in place to the mounting board 16 of the jig assembly and presenting the plank 70 upright with its upper end extending up through the major aperture 61. It will be seen that the major plane of the plank 70 is substantially coaxial with the first channel length 67a and that the adjacent laterally moveable template board insert 66 is positioned more towards the right-hand side of its freedom of movement and defines a narrow gap 71 between itself and an opposing shoulder 72 of the template board 64. The third leg 67c of the channel 67 is unobstructed and this enables a router to be mounted within a channel 67c and moved up and down the narrow groove 71, the router being mounted with a dovetail-forming cutting head, to form a dovetail cut such as illustrated at the left-hand edge of the upper end of the plank 70. When the first dovetail cut has been formed at the left-hand edge of the plank 70 upper end, it is not then necessary to move the plank 70 laterally to cut the next adjacent dovetail cut but instead the template board 64 may simply be shifted laterally between the front and rear rails 62, 63 to the next desired position—and so on—to form each dovetail formation from left to right of the plank 70 upper end.

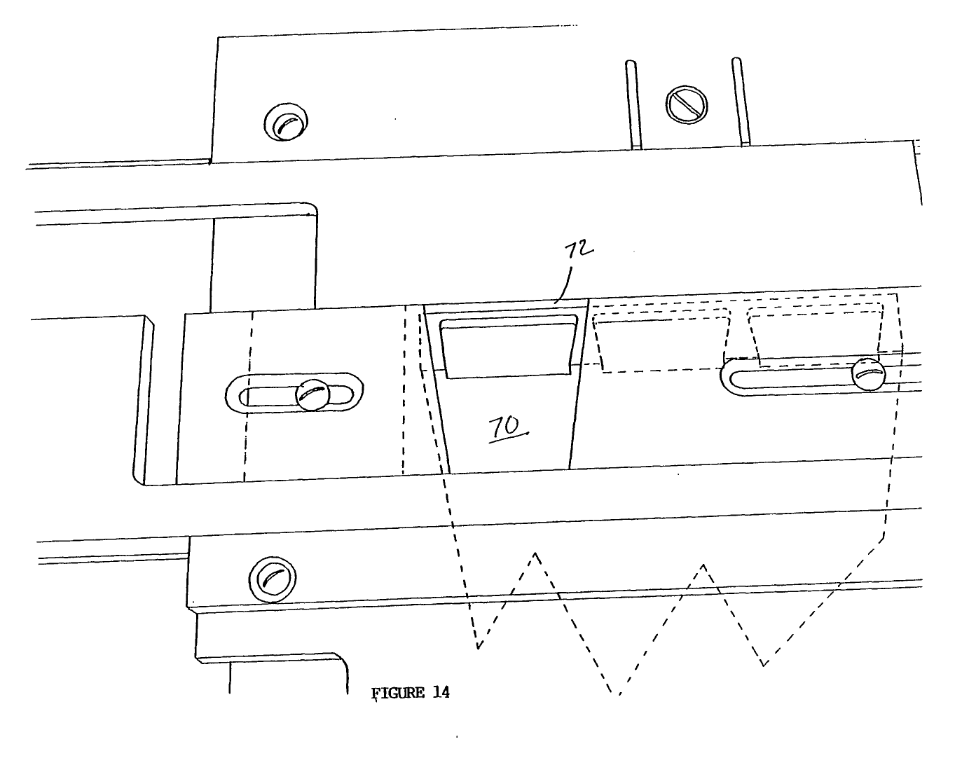

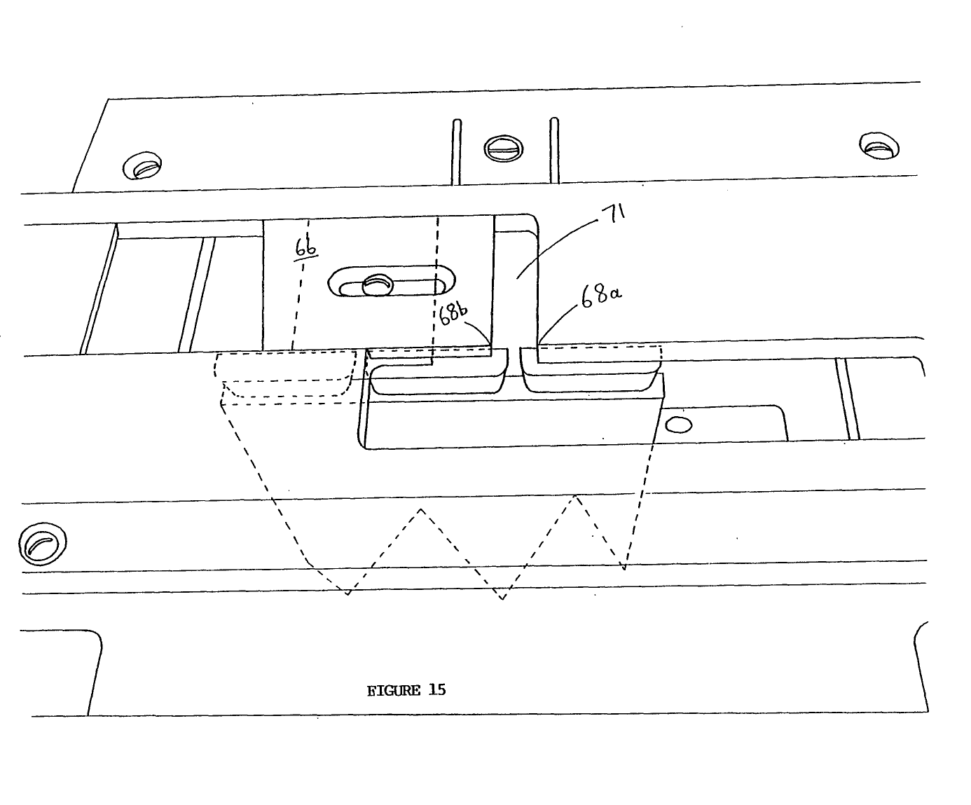

In order to form the corresponding pins—i.e. sockets to receive the dovetails—an intended mating end of a plank 70 is placed on the jig assembly as illustrated in FIG. 14. In contrast to the FIG. 13 view, FIG. 14 is taken from the rear of the jig assembly and it will, therefore, be appreciated that the template 64 retains substantially the same configuration as in FIG. 13 but here the aperture 72 that is used for formation of each pin is a trapezoidal aperture having inclined side walls that are defined by inclined end walls of the adjacent template inserts 65, 66. Again, each adjacent pin formation may be cut by successively moving the template board 64 an appropriate further distance laterally across the major aperture 61.

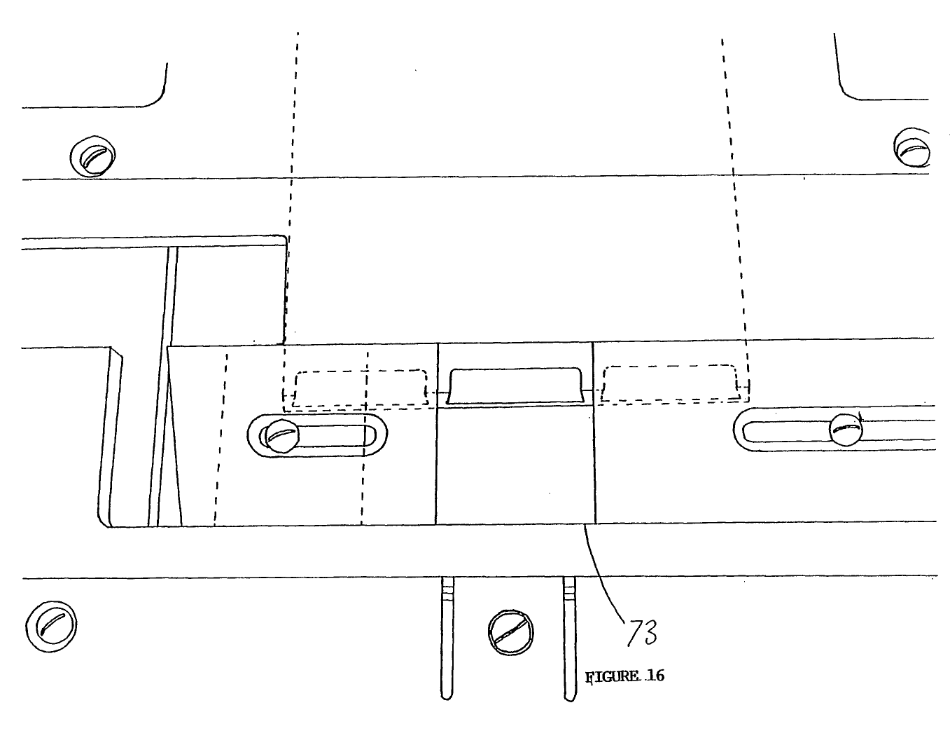

When it is desired to form rounded-backed dovetails and pins the configuration and positioning of the template board 64 is suitably arranged as illustrated in FIG. 15 and FIG. 16, respectively.

As shown in FIG. 15, the plank 70 is positioned within the major aperture 61 of the upper support board 60, lying in a plane that is at a transition between the last length 67c of the channel 67, and the dog-leg part 67b of the channel 67. In practice, the plank 70 has not been repositioned on the jig assembly but rather the template board 64 has been inverted so that the first length 67a of the channel is to the right-hand side and rear of the major aperture 61. Otherwise, the configuration of the template board 64 is the same as in FIG. 13.

With the end of the plank 70 at the interface with the dog-leg 67a and which is adjusted down to a narrow groove/channel 71 by the insert 66, when the router is positioned with its dovetail cutting head extending downwardly into the channel 67, it may be moved both lengthwise of the channel section 67c and perpendicularly to it up through the dog-leg channel groove 71. In so doing it will pass around the opposing corners 68a and 68b at the neck of the dog-leg channel 71 and will thereby be guided to define a rounded back to each adjacent dove-tail formation. As previously, the template 64 is shifted laterally to enable the next adjacent dovetail formation cuts to be made.

Finally, turning to FIG. 16, here the pins for the rounded backed dovetails are formed using a rectangular aperture defined between straight rear edges of the template insert sections 65, 66. It will be appreciated that insert 66 has been inverted relative to its position in the FIG. 13 embodiment in order to define a rectangular aperture 73 rather than a trapezoidal aperture 72.

The operator of the jig assembly and template of the present invention, therefore, has the ability to set up his jig to make a wide range of different joints and can make compound angle mortice and tenon joints as well as, for example, rebates for clock case style hinges that are usually inclined at an angle to the door leaf on which they are formed, a variety of dovetail joints and others and with little resetting of the jig assembly being required to alter the nature of cut and joint being formed.

For example, by positioning the template insert plates 65, 66 farther apart in the first length 67a of the channel 67, a plank end may be accommodated end on within the aperture defined therebetween to enable formation of a desired tenon. Thus, the same setup and configuration of the template 64 can be used for formation of a tenon as can be used for formation of a dovetail.

Although the template assembly of the present invention has been described above in the context of the overall jig assembly, including the adjustable base with workpiece mount enabling the multiple degrees of freedom of movement for formation of compound angle tenons and the like, it will be appreciated that the template arrangement is itself quite unique and provides a number of specific benefits.

Of particular note, the dog-leg feature of the channel of the template enables cutting of round-backed dovetails using a cutting head on a router. In the past it has generally always been necessary to finish such round-backed dovetails by hand with a chisel.

1. A jig for a machine tool for use in joinery which jig comprises a template board means having a template aperture therethrough and to which a machine tool with a cutting head is mounted in use with the cutting head of the machine tool extending through the template aperture to be guided by the perimeter of the template aperture relative to a work-piece, the template aperture opening being selectively adjustable in extent to adjust the form to be cut.

2. A jig for a machine tool as claimed in claim 1, wherein the template aperture is defined between at least a first section of the template board and a second 10 section of the template board means, the first section being moveable toward or away from the second section to adust the opening of the template aperture.

3. A jig for a machine tool as claimed in claim 1 or 2, wherein the template board means is mounted to a support board overlying a major aperture in the support board and is positioned between a pair of guide rails on the support board so as to be slideably moveable across the major aperture in the support board.

4. A jig as claimed in any of claims 1 to 3 wherein the template board means has a centring aperture to receive a dowel hole-forming cutting head therethrough.

5. A jig as claimed in any of claims 1 to 4 and having a branch length or dog-leg part to said template aperture.

6. A jig as claimed in claim 5 wherein the width of the dog-leg/branch part of the aperture may be adusted.

7. A jig for a machine tool as claimed in claim 1 and which is suited for forming joints having compound angles, the jig comprising:
a work-piece mounting board means having means to releasably secure a work piece thereto; and
the template board means overlying the mounting board means and against which the machine tool abuts, in use, the template board means and work piece mounting board means being movable in more than one plane relative to each other to selectively position the work-piece at chosen angles of tilt relative to the work piece and releasably fastenable at the selected position, so that a compound angle joint may be machined by moving the machine tool around the template aperture and without need to re-adjust the position of the work-piece.

8. A jig for a machine tool as claimed in claim 7, wherein the jig is configured as a wall mounting shelf or as a table to present the template board means in a substantially horizontal plane whereby the machine tool may be seated upon the template board means and supported thereby in use.

9. A jig for a machine tool as claimed in claim 8, wherein the template board means hangs from the jig beneath the work-piece board means and is free to swing through an appropriate angle fore and aft of the jig.

10. A jig for a machine tool as claimed in claim 9, wherein the work-piece mounting board means may be turned in its plane.

11. A jig for a machine tool as claimed in claim 10, wherein the template board has front and rear sections that may be moved closer together or farther apart

12. A jig for a machine tool as claimed in claim 10 or 11 wherein the template board means further has adjustably positionable lateral sections intermediate the front and rear sections that may be put closer together or farther apart.

13. A jig for a machine tool as claimed in any preceding claim wherein the template aperture has an elongate slot shape with rounded ends.

14. A jig for a machine tool as claimed in claim 13, wherein the jig has a fence-board means that is pivotally mounted to the work-piece mounting board means, directly or indirectly, to tilt across the face thereof.

15. A jig for a machine tool as claimed in any preceding claim, wherein the template board means is mounted to a frame of the jig so that it may move longitudinally fore or aft of the jig to assist in properly aligning the template aperture over the work-piece.

16. A jig for a machine tool as claimed in any preceding claim, wherein the securing means provided on the work-piece mounting board means are adjustably positionable laterally of the jig.

17. A jig for a machine tool as claimed in claim 16, wherein the securing means are mounted in slots extending rectilinearly across the work-piece mounting board means.

18. A jig for a machine tool as claimed in any preceding claim, wherein the work-piece mounting board means is mounted to a backing board means, which backing board means is pivotally mounted to the template board means, directly or indirectly, and where the work-piece mounting board may be moved laterally across the face of the backing board means to adjust the lateral alignment of the workpiece relative to the template aperture.

19. A jig for a machine tool used in joinery, such as a portable router or the like, and which is suited for forming joints having compound angles, the jig comprising:
a work-piece mounting board means having means to releasably secure a work piece thereto; and
a template board means overlying the mounting board means and against which the machine tool abuts, in use, and defining a template aperture for guiding the machine tool in a pre-defined path relative to the work-piece to machine the work-piece, the template board means and work piece mounting board means being movable in more than one plane relative to each other to selectively position the work-piece at chosen angles of tilt relative to the work piece and releasably fastenable at the selected position, so that a compound angle joint may be machined by moving the machine tool around the template aperture and without need to re-adjust the position of the work-piece.
